(19) United States
(12) Patent Application Publication
(10) Pub. No.: US 2022/0395103 A1
(43) Pub. Date: Dec. 15, 2022

(54) HINGED UNDERFRAME OF A FOLDING BED

(71) Applicant: ZHUOXIAN YANG, Foshan (CN)

(72) Inventor: ZHUOXIAN YANG, Foshan (CN)

(21) Appl. No.: 17/348,086

(22) Filed: Jun. 15, 2021

(51) Int. Cl. A47C 19/12; F16B 12/56; F16C 11/04

(52) U.S. Cl. CPC A47C 19/122; F16B 12/56; F16C 11/04

(57) ABSTRACT

Disclosed is a hinged underframe of a folding bed, which includes a structural main body which comprises hinged middle legs and connectors fixedly arranged on the hinged middle legs. Screw holes are symmetrically defined in each connector, a clamping piece is arranged between the screw holes and is located at the outer side of the corresponding connector, and the top end of each connector is of a planar structure. According to the disclosure, bed legs and a bed frame are folded in half in a space staggering manner, space minimization is achieved, the top of each connector is in plane contact with a bed surface, the supporting force of middle legs on a bed body is maximized, the mutual pressure between pipe orifices of a bed underframe generates interaction to guarantee the relative perpendicularity of the middle legs and the bed surface and to prevent the middle legs from swinging. The hinged underframe of the folding bed disclosed by the disclosure has the advantages of no need of installation, strong supporting force, stability, difficulty in swinging and convenience in packaging and transportation.

### TECHNICAL FIELD

The disclosure relates to the technical field of folding beds, and in particular relates to a hinged underframe of a folding bed.

### BACKGROUND

On the premise of the development trend of international network sales, in order to overcome the limitations of international transportation and reduce the transportation cost, a bed body folding structure is developed in view of minimizing the volume of package.

A bed frame of the folding bed generally comprises a bottom support and an enclosure frame supported on the bottom support, the bottom support and the enclosure frame are folded, so that the whole bed frame can be folded; and the folding bed can be extensively used due to the fact that the volume of the folding bed can be reduced by folding.

However, a folding structure on an existing multifunctional bed body has the problems that hinged installation is inconvenient; insufficient strength of the bed body is caused by insufficient structure; and the bed body shakes due to the middle leg structure.

### SUMMARY

The purpose of the disclosure is to provide a hinged underframe of a folding bed for solving the problems.

The purpose of the disclosure is achieved through the following technical schemes: a hinged underframe of a folding bed comprises a structural main body which comprises hinged middle legs and connectors fixedly arranged on the hinged middle legs; screw holes are symmetrically formed in each connector, and a clamping piece is arranged between the screw holes and located at the outer side of the corresponding connector; and the top end of each connector is of a planar structure.

Typically, each connector is welded to the top of the corresponding hinged middle leg.

Typically, each connector is of an integrated structure formed by stamping an iron plate.

Typically, the structural main body further comprises a front underframe and a rear underframe, each clamping piece is located between the front underframe and the rear underframe, and the front underframe and the rear underframe are in bending connection with the connectors through screws respectively.

Typically, connecting pieces are arranged on the front underframe and the rear underframe, and each connecting piece is of a 7-shaped structure.

The disclosure has the beneficial effects that bed legs and a bed frame are folded in half in a space staggering manner, space minimization is achieved, the top of each connector is in plane contact with a bed surface, the supporting force of middle legs on the bed body is maximized, the mutual pressure between pipe orifices of a bed underframe generates interaction to guarantee the relative perpendicularity of the middle legs and the bed surface and to prevent the middle legs from swinging. The hinged underframe of the folding bed disclosed by the disclosure has the advantages of no need of installation, strong supporting force, stability, difficulty in swinging and convenience in packaging and transportation. The structure of the hinged middle legs and the connectors in the disclosure can be applied to products of a variety of functional furniture and intelligent furniture, with a wide range of application.

### BRIEF DESCRIPTION OF THE DRAWINGS

FIG. 1 is a schematic view of an overall structure of the disclosure.

FIG. 2 is a schematic view of a connector in the disclosure.

FIG. 3 is a side view of a connector in the disclosure.

In the drawings: 1—hinged middle leg; 2—connector; 3—front underframe; 4—rear underframe; 5—clamping piece; 6—screw hole; 7—connecting piece.

### DESCRIPTION OF THE EMBODIMENTS

The following clearly and completely describes the technical scheme in the embodiments of the disclosure with reference to the accompanying drawings in the embodiments of the disclosure. Apparently, the described embodiments are merely a part rather than all of the embodiments of the disclosure. Based on the embodiments of the disclosure, all other embodiments obtained by a person of ordinary skill in the art based on the embodiments of the disclosure without creative efforts shall fall within the protection scope of the disclosure.

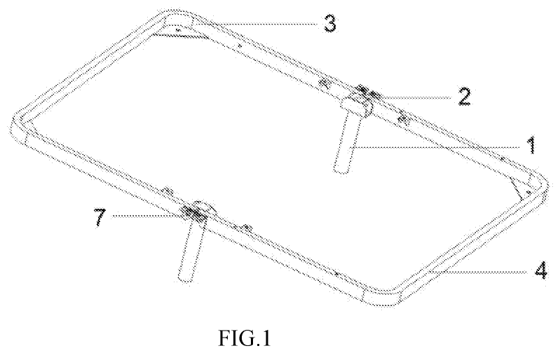

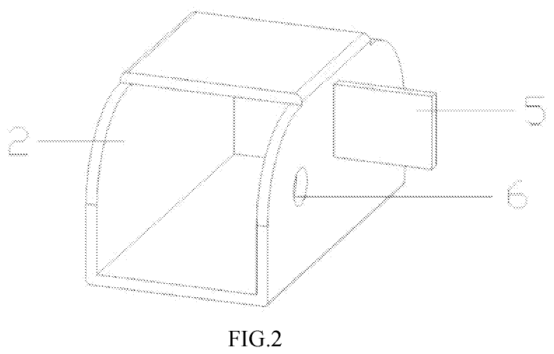

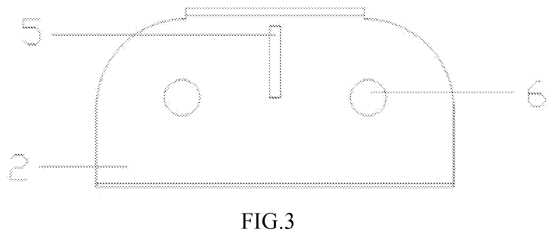

As illustrated in FIGS. 1-3, a hinged underframe of a folding bed comprises a structural main body which comprises hinged middle legs 1 and connectors 2 fixedly arranged on the hinged middle legs 1, wherein screw holes 6 are symmetrically arranged on each connector 2, and a clamping piece 5 is arranged between the screw holes 6 and is located at the outer side of the corresponding connector 2; and the top end of each connector 2 is of a planar structure.

Wherein each connector 2 is welded to the top of the corresponding hinged middle leg 1; each connector 2 is of an integrated structure formed by stamping an iron plate; the structural main body further comprises a front underframe 3 and a rear underframe 4, each clamping piece 5 is located between the front underframe 3 and the rear underframe 4, and the front underframe 3 and the rear underframe 4 are in bending connection with the connectors 2 through screws; and connecting pieces 7 are arranged on the front underframe 3 and the rear underframe 4, and each connecting piece is of a 7-shaped structure.

It should be noted that each connecting piece 7 is of a 7-shaped structure, and the two surfaces of each connecting piece 7 are fixedly connected with the underframe and the bed surface through screws.

It should be noted that the front underframe 3 and the rear underframe 4 are connected with the connectors through the screws respectively, and the front underframe 3 and the rear underframe 4 can do circular motion by taking respective screw as a center of a circle, thereby achieving a fold-in-half effect.

The disclosure discloses a hinged underframe of a folding bed, when the front underframe 3 and the rear underframe 4 are unfolded and placed on the horizontal ground, pipe orifices of the front underframe 3 and the rear underframe 4 are used for clamping the clamping pieces 5 and applying pressure to the same, and a relative perpendicular state between the hinged middle legs and the front underframe 3 and the rear underframe 4 which are horizontally unfolded can be achieved through the interaction of the pipe orifices of the front underframe 3 and the rear underframe 4, thereby achieving the purpose of preventing the hinged middle legs 1 from shaking left and right.

According to the hinged underframe of the folding bed, when the front underframe 3 and the rear underframe 4 are unfolded to be in a horizontal state, a bed surface installed on the front underframe 3 and the rear underframe 4 are just pressed on the tops of the connectors 2, and when the bed surface is loaded, the hinged middle legs 1 can provide supporting force through contact planes of the connectors 2, thereby achieving the purpose of consolidating the bed surface.

It is clear to those skilled in the art that the disclosure is not limited to the details of the above exemplary embodiments, and that the disclosure can be implemented in other specific forms without departing from the spirit or essential features of the disclosure. Therefore, the embodiments should be regarded as exemplary and non-limiting from either point of view. The scope of the disclosure is defined by the appended claims rather than the foregoing description, thus all modifications falling within the meaning and scope of the equivalent elements of the claims are embraced within the disclosure. Any reference numeral in the claims should not be construed as limiting the claims involved.

Although this specification has been described with reference to the embodiments, not each embodiment contains only one independent technical solution. The specification is so described only for clarity. Those skilled in the art should regard the specification as a whole, the technical schemes of various embodiments may also be combined appropriately to form other embodiments which can be understood by those skilled in the art.

What is claimed is:

1. A hinged underframe of a folding bed, comprising a structural main body, which comprises:
hinged middle legs; and
connectors fixedly arranged on the hinged middle legs;
wherein screw holes are symmetrically defined in each connector, a clamping piece is arranged between the screw holes and is located at an outer side of the corresponding connector, and a top end of each connector is of a planar structure.

2. The hinged underframe of claim 1, wherein each connector is welded to a top of the corresponding hinged middle leg.

3. The hinged underframe of claim 1, wherein each connector is of an integrated structure formed by stamping an iron plate.

4. The hinged underframe of claim 1, wherein the structural main body further comprises a front underframe and a rear underframe, each clamping piece is located between the front underframe and the rear underframe, and the front underframe and the rear underframe are in bending connection with the connectors through screws.

5. The hinged underframe of claim 4, wherein connecting pieces are arranged on the front underframe and the rear underframe, and each connecting piece is of a 7-shaped structure.
